(19) United States
(12) Patent Application Publication
(10) Pub. No.: US 2025/0161939 A1
(43) Pub. Date: May 22, 2025

(54) LINEAR DIAGNOSTIC MICROFLUIDIC CARTRIDGE

(71) Applicant: CFD Research Corporation, Huntsville, AL (US)

(72) Inventors: David Edwin Gaddes, III, Huntsville, AL (US); Trevor Jaxon Sudarth, Huntsville, AL (US); Ketan Harendrakumar Bhatt, Huntsville, AL (US)

(21) Appl. No.: 18/952,740

(22) Filed: Nov. 19, 2024

Related U.S. Application Data
(60) Provisional application No. 63/601,104, filed on Nov. 20, 2023.

(51) Int. Cl. B01L 3/00

(52) U.S. Cl. CPC B01L 3/502715; B01L 2200/027; B01L 2300/027; B01L 2300/044

(57) ABSTRACT

A system for analyzing a sample can include a sample tube with an input end having a removable lid and an output end, and a microfluidic device. The microfluidic device may include a port member configured to couple with the output end; a sample distribution member coupled with the port member and having a microfluidic network with microfluidic channels; reaction chambers fluidly coupled with the microfluidic channels; and a reactor member configured to generate and display light signals on a display, the light signals generated based on reactions in the reaction chambers and indicating results of the reactions.

### CROSS-REFERENCE TO RELATED APPLICATIONS

This patent application claims priority to U.S. Provisional Application No. 63/601,104 filed Nov. 20, 2023, which is incorporated herein by specific reference in its entirety.

### BACKGROUND

### Field

This invention relates to a diagnostic system that is configured to test a sample to determine the present of target substances, which react with reagents of the diagnostic system. More specifically, the present invention pertains to diagnostic systems that are configured to test the sample for the presence of one or more target substances that react with multiple reagents stored in respective reaction chambers.

### Description of Related Art

Biological samples may be analyzed using reagents to detect, identify, or quantify presence of particular substances (e.g., target agents) in the sample. The reagents may be selected based on the ability to react selectively with certain target substances in the samples. The samples may be mixed with the selected reagents, and the results may be observed to identify the presence of the target substances. For example, in some instances, the presence of target substances in the sample may be represented as various colors. In some instances, the results may be represented using different reactions, such as changes in characteristics of the samples. The identification of the target substances may allow detection of different diseases and/or conditions that may be present in the samples and corresponding sources of the samples.

However, such identification of the target substances may be difficult and/or unclear as the reaction may not be distinct or difficult to interpret. Particularly, such distinct identification may be difficult using portable systems. Additionally, testing the sample with respect to multiple reagents at the same time may increase the difficulty of interpreting the results.

In summary, a diagnostic system that provides a portable sample testing device for analyzing a sample with respect to multiple reagents to identify presence of substances that generate results that are clear and easy to understand does not exist. However, such a diagnostic system is desirable.

### SUMMARY

In some embodiments, a system for analyzing a sample can include a sample tube with an input end having a removable lid and an output end, and a microfluidic device. The microfluidic device may include a port member configured to couple with the output end; a sample distribution member coupled with the port member and having a microfluidic network with microfluidic channels; reaction chambers fluidly coupled with the microfluidic channels; and a reactor member configured to generate and display light signals on a display, the light signals generated based on reactions in the reaction chambers and indicating results of the reactions.

In some embodiments, a system for analyzing a sample can include a sample tube with an input end having a removable lid and an output end, and a microfluidic device. The microfluidic device may include a port member configured to couple with the output end of the sample tube; a sample distribution member coupled with the port member and having a microfluidic network with one or more microfluidic channels; one or more reaction chambers fluidly coupled with the one or more microfluidic channels; a reactor member configured to generate and display light signals on a display, the light signals generated based at least on reactions in the one or more reaction chambers and indicating results of the reactions; a battery configured to power the reactor member; a top cover with a first slot configured to receive the sample tube therein, and a second slot configured to provide viewing window for the display; and a bottom member mating with the top cover to enclose the port member, the sample distribution member, the reactor member, and the battery.

In some embodiments, the input end includes an opening that is configured to receive the sample, in which the removable lid is adapted to cover the input opening to seal the input end of the sample tube. In some embodiments, the output end of the sample tube includes a port adapter configured to couple with the port member. In some embodiments, the port member has a tapered input tip configured to puncture the port adapter at the output end to obtain the sample from the port adapter. In some embodiments, the port adapter is configured to couple with a port in the microfluidic device.

In some embodiments, the one or more microfluidic channels include a microfluidic channel inlet fluidly coupled with the output end of the port member. In some embodiments, the microfluidic device further comprises one or more light pipes (e.g., waveguide, fiber optic, etc.) coupled with the one or more reaction chambers, the one or more light pipes configured to guide the light signals into the one or more reaction chambers.

In some embodiments, reactor member may include: a first circuit board configured to receive the microfluidic device covered with an inner cover. In some embodiments, the first circuit board may include: a set of LEDs corresponding to the one or more reaction chambers, the set of LEDs configured to transmit light into the one or more reaction chambers using the one or more light pipes; and a heating member configured to provide heat to the one or more reaction chambers. In some embodiments, the reactor member may include a second circuit board coupled to the first circuit board.

In some embodiments, the second circuit board may include: one or more receivers configured to receive the light signals from the one or more reaction chambers. In some embodiments, the reactor member further comprises the display including a set of indicators corresponding to the one or more reaction chambers, the set of indicators configured to indicate results of the reaction between the sample and the reagents.

In some embodiments, the inner cover is configured to direct the light from the one or more reaction chambers to corresponding receivers without interacting among the light signals. In some embodiments, the system further comprises a connector coupled between the first circuit board and the second circuit board, in which the connector places the second circuit board above the first circuit board with a space therebetween. In some embodiments, the microfluidic device covered with the inner cover is placed between the first circuit and the second circuit. In some embodiments, the heating member is an electronic heater. In some embodiments, the output end of the sample tube includes a puncturable membrane material, such as an elastomer, rubber, or thermoplastic. In some embodiments, the one or more reaction chambers are aligned linearly with respect to each other.

In some embodiments, the system further includes one or more reagents placed in the one or more reaction chambers, the one or more reagents adapted to interact with a target analyte in the sample. In some embodiments, at least one of the one or more reagents is configured to test for a sexually transmitted disease. Additionally or alternatively, in some embodiments, at least one of the one or more reagents is configured to detect a virus.

In some embodiments, the sample tube is configured for receiving a swab, the reaction tube being configured for passing the content of the swab to the port member. In some embodiments, the sample tube includes a spout at in the input end, wherein the removable lid is configured to cover the spout. In some embodiments, the one or more reaction chambers include corresponding one or more vents configured to permit air flow through the reaction chambers. In some embodiments, the system further comprises a plunger adapted to fit into the sample tube and function as a syringe for delivering the sample into the microfluidic network to the reaction chambers. In some embodiments, the system further comprises a sample tube adapter coupled to the main slot of the top cover, the sample tube adapter configured to receive and secure the sample tube in place. In some embodiments, the one or more reaction chambers include a top portion that allows the light signals to transmit through.

In some embodiments, a method of analyzing a sample can include: providing the system for analyzing a sample as discussed above. The method may further include introducing a sample into the one or more reaction chambers and observing an indicator of the system of whether or not the sample includes a target analyte.

In some embodiments, the method can include: obtaining a sample in a sample tube, the sample tube having an input end with an input opening where the sample is obtained through, the sample tube also having an output end having a port adapter, the port adapter configured to release the sample in response to being punctured; attaching the port adapter of the sample tube to a port member of a microfluidic device, the port member having a conical body with a tapered input tip adapted to couple with the port adapter, and having an output end with a port conduit extending between a tip opening at the input tip to an output opening at the output end, wherein the tapered input tip is configured to puncture the port adapter to obtain the sample from the sample tube; distributing the sample to one or more reaction chambers, by a sample distribution member having a microfluidic network with one or more microfluidic channels, the one or more microfluidic channels having a microfluidic channel inlet fluidly coupled with the output opening at the output end of the port member, and having a microfluidic channel outlet fluidly coupled with the one or more reaction chambers, the sample distribution member being located between a first circuit board and a second circuit board of a reactor member; providing heat to the one or more reaction chambers by a heating member coupled to the first circuit board; interacting the distributed sample with a reagent pre-deposited in each reaction chamber, the reagent adapted to provide a colorimetric reading upon interaction with a target analyte in the sample; transmitting light into the one or more reaction chamber by one or more LEDs coupled to the first circuit board, the light configured to generate light signals based at least on the colorimetric reading; receiving the light signals at one or more receivers coupled to the second circuit board; determining results of the interaction between the reagent and the target analyte by performing colorimetric analysis on the light signals; and displaying the results on a display coupled to the second circuit board.

In some embodiments, the sample is obtained via a sample tube, the sample adapted to couple with a microfluidic device configured to distribute the sample into the one or more reaction chambers. In some embodiments, the one or more reaction chambers each include a reagent pre-deposited in the one or more chambers to interact with a target analyte in the sample. In some embodiments, the indicator is determined based on light signals corresponding to the one or more chambers, the light signals generated based on interaction between the reagent and the sample.

The foregoing summary is illustrative only and is not intended to be in any way limiting. In addition to the illustrative aspects, embodiments, and features described above, further aspects, embodiments, and features will become apparent by reference to the drawings and the following detailed description.

In some embodiments, a method of manufacturing a sample analyzing system may include: obtaining a bottom member, the bottom member including one or more support rods configured to support a reactor member; obtaining a sample distribution member, the sample distribution member coupled with a fluidic seal to fluidly seal one or more microfluidic channels of a microfluidic network within the sample distribution member, the sample distribution member also having a port member fluidly coupled with the one or more microfluidic channels, the port member having a conical body with a tapered input tip; attaching one or more reaction chambers to the sample distribution member, the one or more reaction chambers fluidly coupled with the one or more microfluidic channels, each reaction chamber containing a reagent that is adapted to provide a colorimetric reading upon interaction with a target analyte; covering the one or more reaction chambers with an inner cover, the inner cover configured to separate the one or more reaction chambers with respect to each other; attaching a battery, one or more LEDs, a heating member, one or more receivers, and a display to the reactor member, the one or more LEDs being attached to a first circuit board and the battery, the one or more receivers, and the display being attached to a second circuit board of the reactor member, the first circuit board and the second circuit board connected by one or more connectors, wherein the second circuit board is placed above or adjacent to the first circuit board with a space therebetween; placing the sample distribution member covered with the inner cover at least partially between the first circuit board and the second circuit board; placing the reactor member on the one or more support rods, the first circuit board being placed on the one or more support rods; covering the reactor member with a top cover, the top cover configured to mate with the bottom member to enclose the port member, the sample distribution member, the reactor member and the fluidic seal, the top cover having a first slot and a second slot, the first slot configured to receive a sample tube therein, and the second slot configured to allow observation of the display; and placing the sample tube through the main slot of the top cover to be removably coupled with the port member, the sample tube having an input end and an output end, the sample tube configured to obtain a sample to be analyzed through the input end, wherein the port member may connect with the output end of the sample tube, the port member configured to distribute the sample to the one or more reaction chambers through the sample distribution member.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A includes a perspective view of a diagnostic system including a sample tube and a microfluid reactor device;

FIG. 1B includes a top view of the diagnostic system of FIG. 1A;

FIG. 1C includes a side view of the diagnostic system of FIG. 1A;

FIG. 1D includes a front view of the diagnostic system of FIG. 1A;

FIG. 1E includes an exploded view of the diagnostic system of FIG. 1A;

FIG. 2A includes a perspective view of a reactor member;

FIG. 2B includes a top view of the reactor member of FIG. 2A;

FIG. 2C includes a side view of the reactor member of FIG. 2A;

FIG. 2D includes a front view of the reactor member of FIG. 2A;

FIG. 2E includes a bottom view of the reactor member of FIG. 2A;

FIG. 3A includes a perspective view of an inner cover;

FIG. 3B includes another perspective view of the inner cover of FIG. 3A;

FIG. 3C includes a top view of the inner cover of FIG. 3A;

FIG. 3D includes a side view of the inner cover of FIG. 3A;

FIG. 3E includes a front view of the inner cover of FIG. 3A;

FIG. 3F includes a bottom view of the inner cover of FIG. 3A;

FIG. 4A includes a perspective view of a sample tube;

FIG. 4B includes a side view of the sample tube of FIG. 4A;

FIG. 4C includes a top view of the sample tube of FIG. 4A;

FIG. 4D includes a bottom view of the sample tube of FIG. 4A;

FIG. 4E includes a front view of the sample tube of FIG. 4A;

FIG. 4F includes a side view of a swab;

FIG. 4G includes a perspective view of the sample tube of FIG. 4A with a sample tube adapter and a removable lid;

FIG. 4H includes another view of the sample tube of FIG. 4A with a sample tube adapter and a removable lid;

FIG. 4I includes an exploded view of the sample tube of FIG. 4A with a sample tube adapter and a removable lid;

FIG. 5A includes a perspective view of a sample distribution member;

FIG. 5B includes a top view of the sample distribution member of FIG. 5A;

FIG. 5C includes a side view of the sample distribution member of FIG. 5A;

FIG. 5D includes another view of the sample distribution member of FIG. 5A;

FIG. 5E includes a front view of the sample distribution member of FIG. 5A;

FIG. 5F includes a bottom view of the sample distribution member of FIG. 5A;

FIG. 6A includes a perspective view of a top cover;

FIG. 6B includes a top view of the top cover of FIG. 6A;

FIG. 6C includes a side view of the top cover of FIG. 6A;

FIG. 6D includes a front view of the top cover of FIG. 6A;

FIG. 6E includes a bottom view of the top cover of FIG. 6A;

FIG. 7A includes a perspective view of a bottom cover;

FIG. 7B includes a top view of the bottom cover of FIG. 7A;

FIG. 7C includes a side view of the bottom cover of FIG. 7A;

FIG. 7D includes a front view of the bottom cover of FIG. 7A;

FIG. 7E includes a bottom view of the bottom cover of FIG. 7A;

FIG. 8A includes a perspective view of a sample distribution member placed within a reactor member;

FIG. 8B includes a front view of sample distribution member of placed within a reactor member;

FIG. 8C includes a perspective view of a sample distribution member placed within a reactor member of FIG. 8A without an inner cover; and

FIG. 8D includes a front view of a sample distribution member placed within a reactor member of FIG. 8A without an inner cover.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology relates to a diagnostic system that is configured to test a sample in an analysis protocol that may require heat. The current diagnostic system is configured for receiving a biological sample and testing the biological sample in one or more analytical reaction chambers. Additionally or alternatively, the reaction chambers may be heated using a heater. The reaction chambers generate a colorimetric result when the target is present in the sample. The diagnostic system can then provide an indication to the user of the presence or absence of the target in the sample.

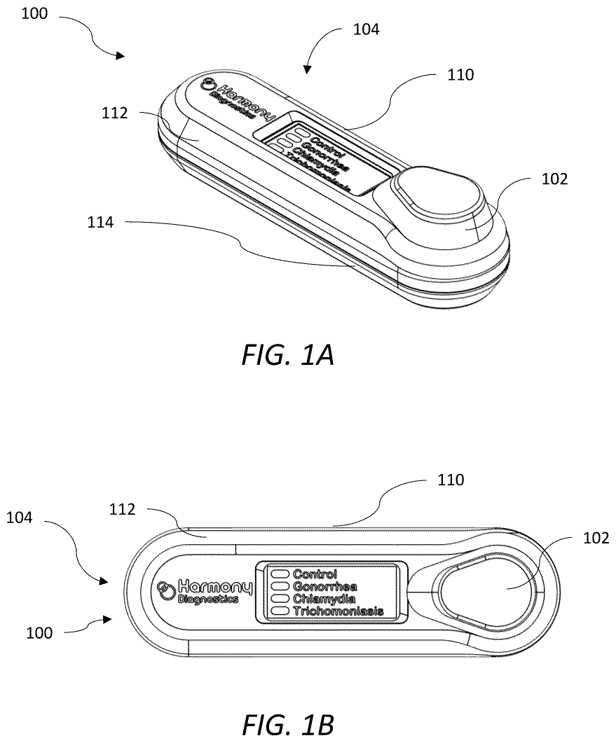

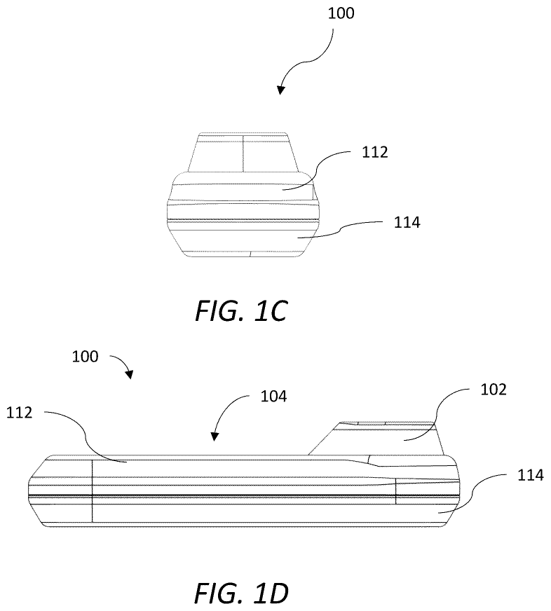

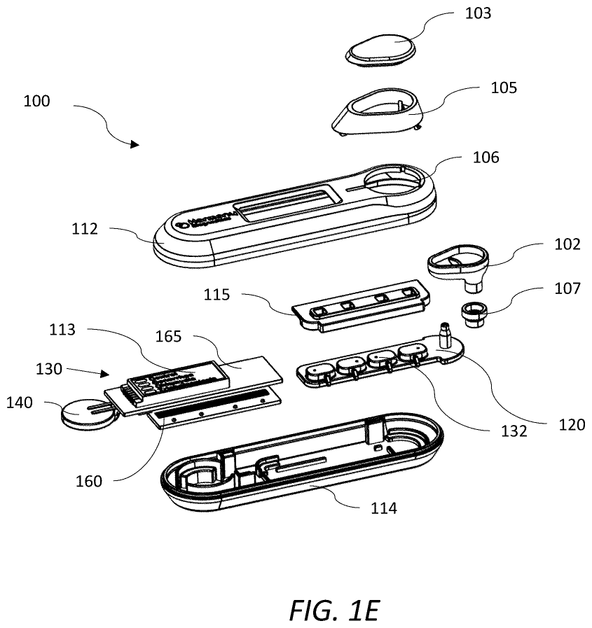

FIGS. 1A-1E illustrate an example diagnostic system 100 in varying perspectives. For example, FIG. 1E illustrates an exploded view of the diagnostic system 100. In some embodiments, the diagnostic system 100 may include a sample tube 102 and a microfluidic reactor device (“microfluidic device”) 104. The diagnostic system 100 may include a body 110 having a top cover 112 and a bottom member 114 configured to mate together and enclose the reactor member 130, a sample distribution member 120, and an inner cover 115. The sample tube 102 fits into a tube adapter 105 that includes a lid 103.

The microfluidic device 104 may be configured to receive the sample tube 102 through a first opening 106 (e.g., tube opening) of the top cover 112. The sample tube 102 received through the first opening 106 may be received by the sample distribution member 120. In these and other embodiments, the microfluidic device 104 may receive samples through the sample tube 102. For instance, the samples may go through the sample tube 102 to the sample distribution member 120 of the microfluidic device 104. Additionally, the sample distribution member 120 may include one or more reaction chambers 132 that may receive the samples. The reaction chambers 132 may include corresponding reaction reactants configured to react target substances (e.g., target agents, target analytes, etc.) with the samples.

In some embodiments, the reactor member 130 may be configured to receive the sample distribution member 120. In these and other embodiments, the reactor member 130 may include a display 113 configured to display results of reactions between the reactants and the target substances in the samples within the reaction chambers. In some embodiments, the reactor member 130 may include a first circuit board 160 and a second circuit board 165. The reactor member 130 may further include a battery 140 configured to provide power to the first circuit board 160 and the second circuit board 165.

In some embodiments, a portion of the sample distribution member 120 may be covered by the inner cover 115. The inner cover 115 may be configured to separate the reaction chambers 132 to prevent the reaction products from the reaction vessels 132 from interfering with each other.

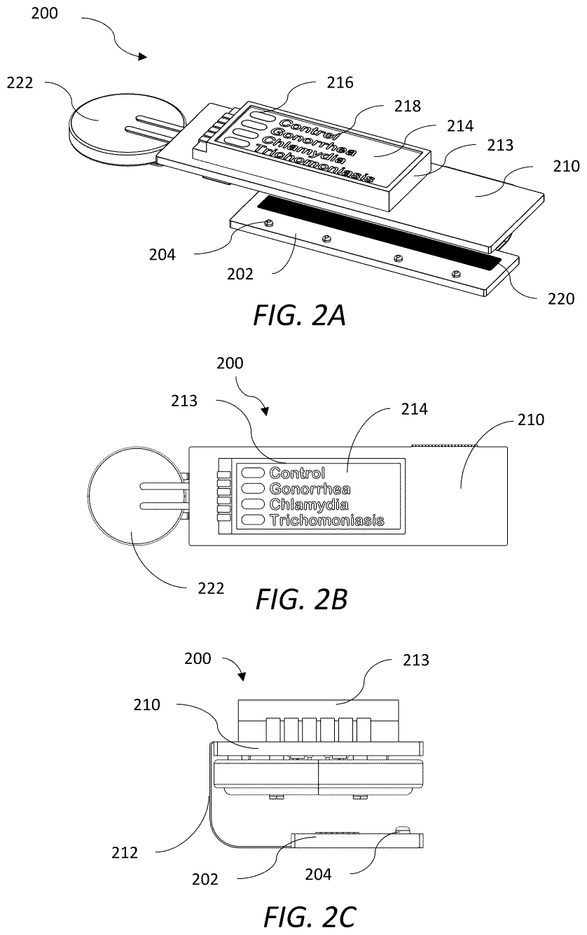

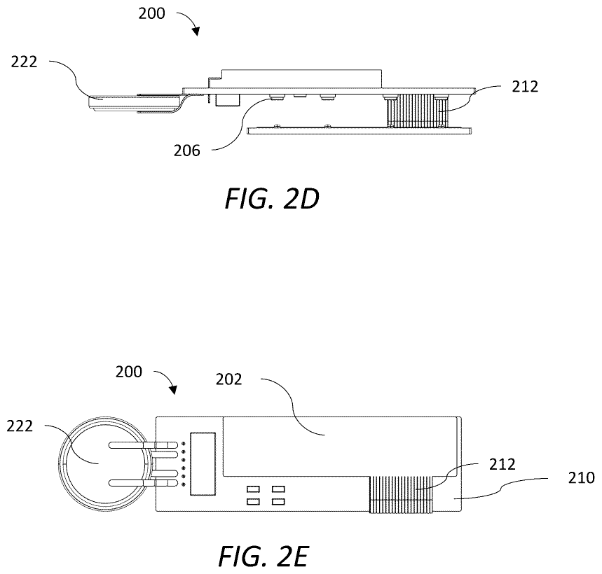

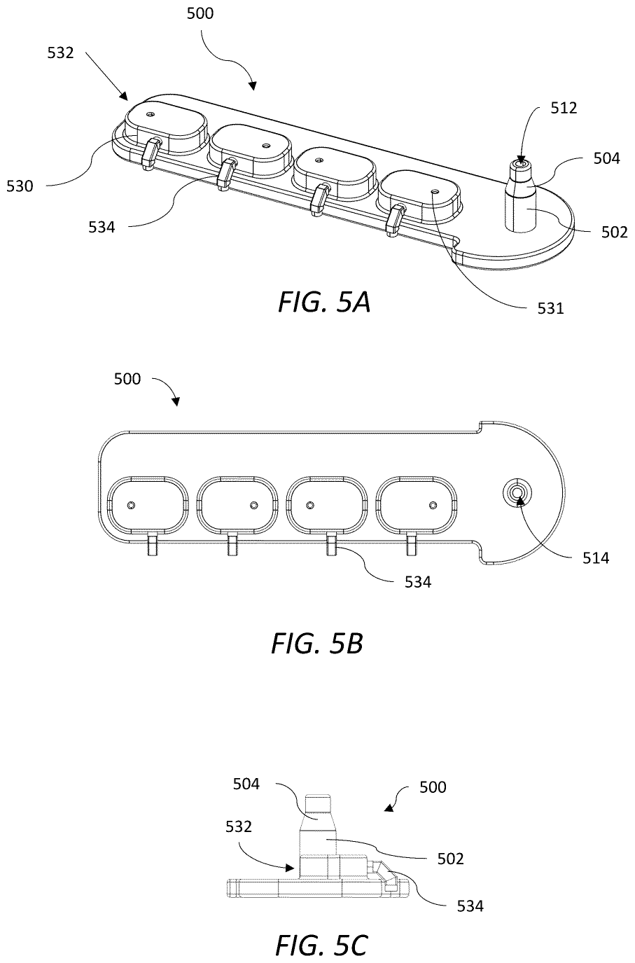

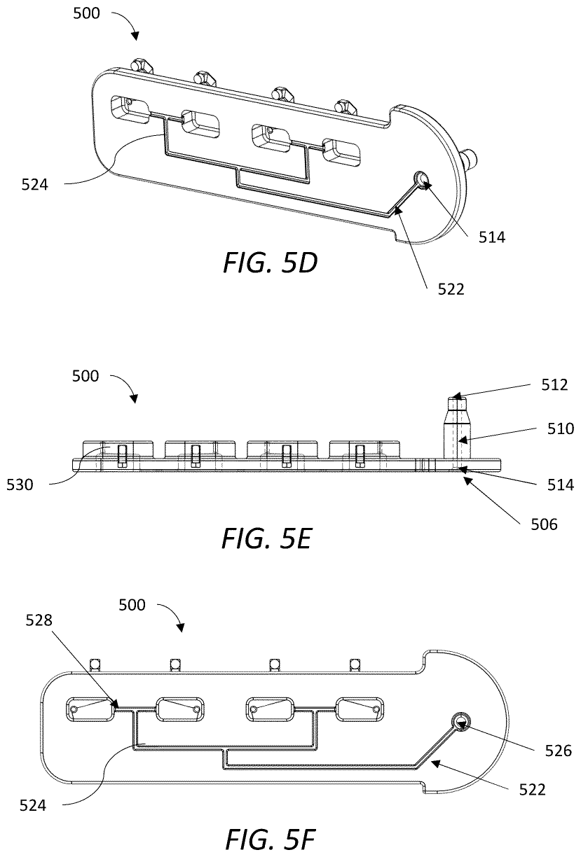

FIGS. 2A-2E illustrate a reactor member 200, such as the reactor member 130 of FIG. 1E, in varying perspectives. In some embodiments, the reactor member 200 may include a first circuit board 202 and a second circuit board 210. In some embodiments, the first circuit board 202 may be coupled to the second circuit board 210 by a set of connectors 212. The connectors 212 may be configured to transmit data (e.g., results) of the colorimetric analysis of the light signals from the receivers 206 to the second circuit board 210. Additionally or alternatively, the connectors 212 may be configured to provide structure support to hold the second circuit board 210 above the first circuit board 202 at a certain height. For example, the certain height may be determined to allow a sample distribution member (such as a sample distribution member 500 further illustrated and described with respect to FIGS. 5A-5F of present disclosure) of a microfluidic device to be placed between the first circuit board 202 and the second circuit board 210.

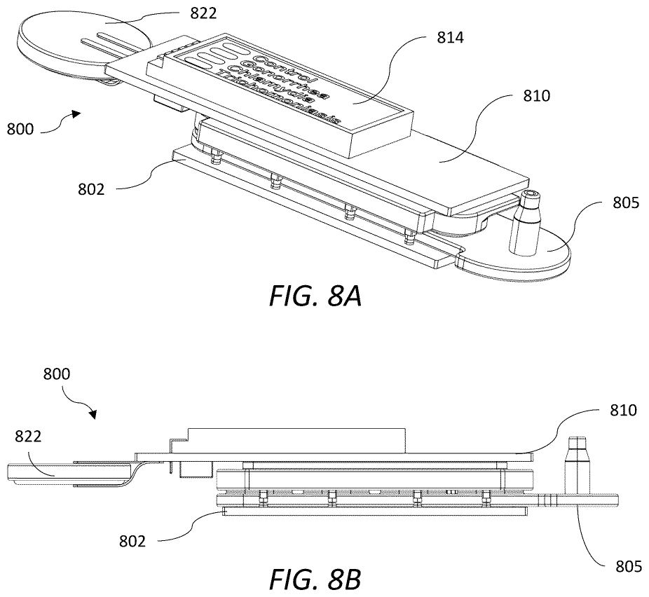

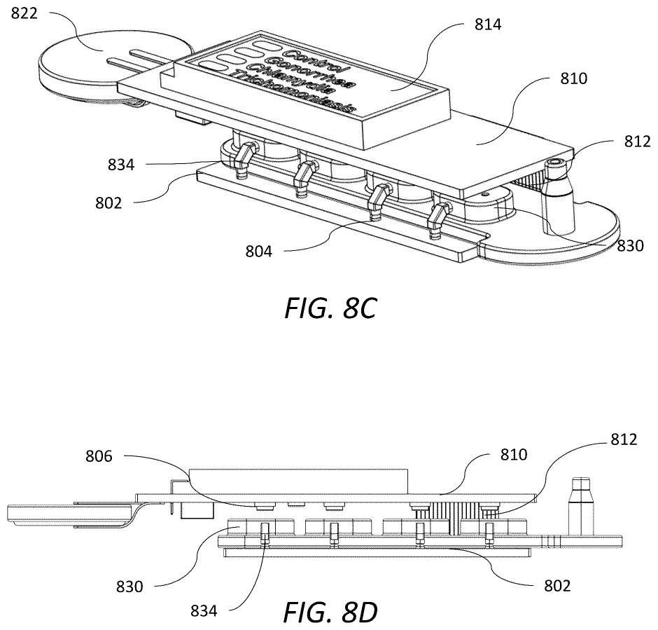

In these and other embodiments, the reactor member 200 may be configured to receive the sample distribution member 805 between the first circuit board 202 and the second circuit board 210 as illustrated in FIGS. 8A-8D. At least a portion of the sample distribution member may be placed between the first circuit board 202 and the second circuit board 210.

In some embodiments, the first circuit board 202 may include a set of LEDs 204 corresponding to the one or more reaction chambers of the sample distribution member. The set of LEDs 204 may be configured to transmit light into the one or more reaction chambers to generate light signals indicating results of the reaction between the reagents and the sample within the reaction chambers.

In some embodiments, the reactor member 200 may include one or more receivers 206 corresponding to the LEDs 204. In these and other embodiments, the light signals generated by the LEDs and the reaction chambers may be received by the receivers 206. In some embodiments, the receivers 206 may be located on a bottom portion of the second circuit 210. In these and other embodiments, the light signals may be transmitted through a top portion of the reaction chambers to reach the receivers 206. The top portion of the reaction chambers may be configured and/or include materials that allow light to transmit through. In these and other embodiments, the receivers 206 may be configured to receive the light signals and perform a colorimetric analysis on the light signals to determine whether the sample was properly received by the reaction chambers and whether sought—for reaction happened between the sample and the reagents.

In some embodiments, the second circuit board 210 may include a display 214 placed in a display housing 213. The display 214 may be configured to display the results of the colorimetric analysis of the light signals. For example, the display 214 may include one or more indicators 216 corresponding to the one or more reaction chambers and/or the light signals received by the receivers 206. In these and other embodiments, the indicators 216 may indicate the results of the reactions between the one or more target substances in the sample and the reagents by different colors. For example, a positive result (e.g., a target analyte present in the sample) may be represented by a green light on the indicators 216. Additionally or alternatively, a negative result (e.g., the target analyte not present in the sample) may be represented by a red light on the indicators 216. While illustrated as green and red lights, the indicators 216 may include different colors. For instance, in some embodiments, the positive result may be represented using the red light and the negative result may be represented using the green light. Being on versus being off can also be another distinguishing feature of the light indicators 216, with on being presence and off being absence of the target analyte. Also, different colors may be used, and the different colors may have different definitions and provide different data to the user. For example, a color can be used to indicate that the test failed or other information.

Additionally or alternatively, while the indicators 216 are illustrated as including an oval shape in the Figures, the indicators 216 may include any other suitable shapes, such as a rectangle, square, circle, triangle, among others.

In some embodiments, the display 214 may be configured to further display labels 618. For example, the labels 218 may provide description of the condition the sample is being analyzed for. For instance, the labels 218 may include gonorrhea, chlamydia, trichomoniasis, among others. Additionally or alternatively, the labels 218 may include a control label configured to indicate proper operation of the system. The lights can be illuminated to identify the presence of the indication by the label or off to identify the absence of the indication by the label. Also, green can be the presence of the target analyte, and red can be absence of the target analyte, or vice versa, or other color and/or illumination indication.

In some embodiments, the reactions between the sample and the reagents within the reaction chambers may require heat. For instance, the heat may be needed to initiate and/or speed up the reactions. In these and other embodiments, the heat may be provided to the reaction chambers using a heating member 220. The heating member 220 may be located on the first circuit board 202 in a manner such that when the sample distribution member is placed on the first circuit board 202, at least a portion of the reaction chambers are in contact with the heating member 220 (e.g., heading pad). In some embodiments, the heating member 220 may be an electric heater.

In some embodiments, the first circuit board 202 and the second circuit board 210 and different components included in the first circuit board 202 and the second circuit board 210 may be powered by a battery 222. For instance, the battery 222 may be coupled to the second circuit board 210. In some embodiments, the battery 222 may include any suitable type of battery. For example, the battery 222 may include a coin cell battery.

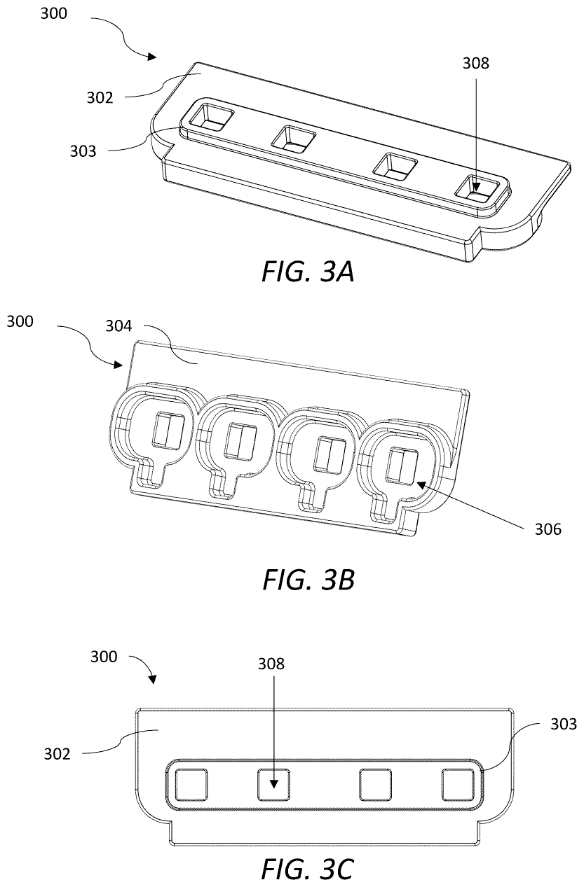

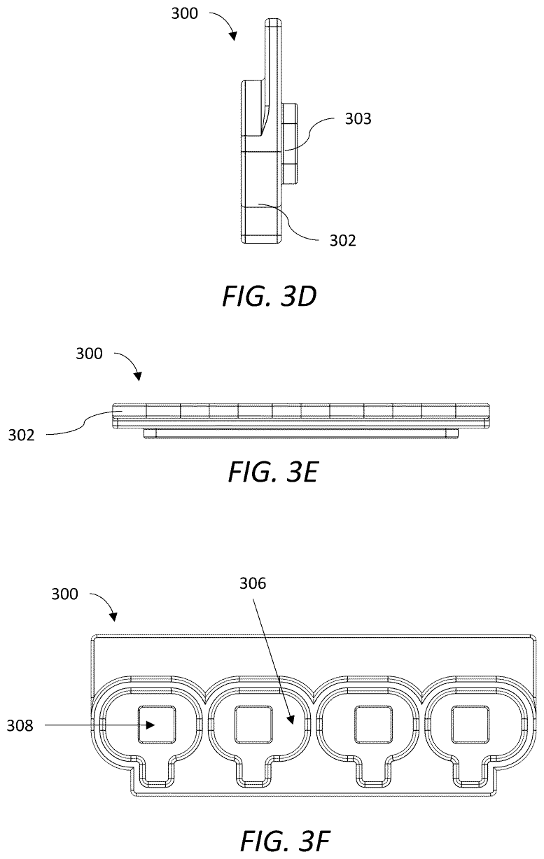

FIGS. 3A-3F illustrate an inner cover 300 in varying perspectives. In some embodiments, the inner cover 300 may correspond to the inner cover 115 of FIG. 1E. In some embodiments, the inner cover 300 may be configured to at least partially cover a sample distribution member (120 in FIG. 1E; 500 in FIGS. 5A-5F). For instance, the inner cover 300 may cover one or more reaction chambers of the sample distribution member. In some embodiments, the inner cover 300 may be shaped and/or sized to be placed between a first circuit board 202 and a second circuit board 210 of the reactor member (e.g., the reactor member 200 of FIG. 2A-2E) while covering the sample distribution member 500. In some embodiments, the inner cover 300 may include a cover body 302. The cover body 302 may further include an upper portion 303 on a first face of the cover body 302. The upper portion 303 may include one or more reaction openings 308 corresponding to the one or more reaction chambers. The reaction openings 308 may be configured to direct light signals from the reactor chambers to be received by receivers of the reactor member without interfering among the light signals from different reaction chambers. Additionally, the cover body 302 may include one or more chamber slots 306 on a second face of the cover body 302. For instance, the chambers slots 306 may be configured to cover the one or more reaction chambers when the inner cover 300 is placed on the sample distribution member. In these and other embodiments, the chamber slots 306 may include and/or correspond to the reaction openings 308.

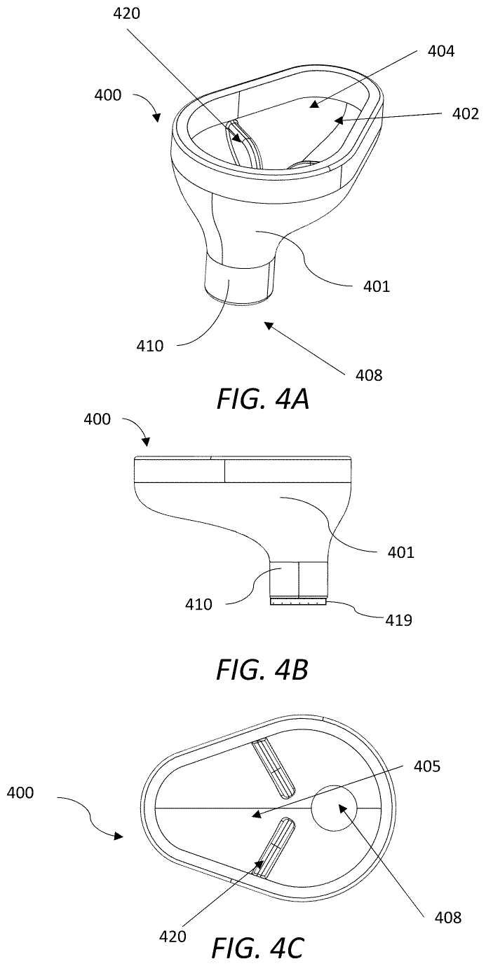

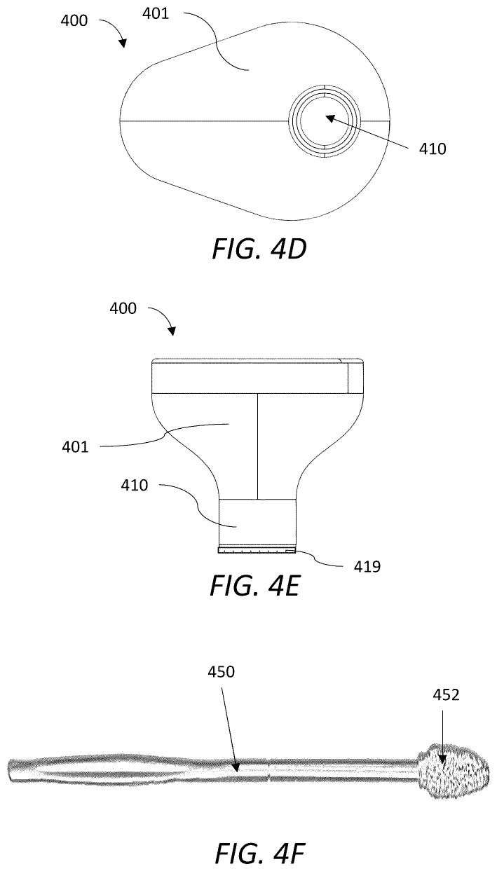

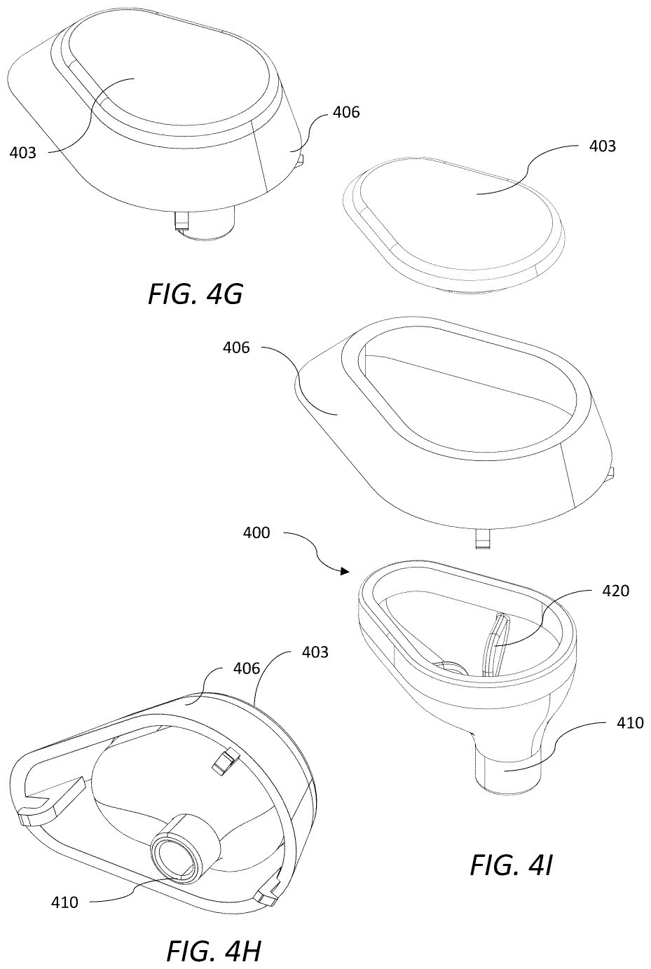

A sample tube 400 corresponding to the sample tube 102 of FIGS. 1A-1E is illustrated in FIGS. 4A-4I. The sample tube 400 is shown to include an input end 402 having an input opening 404 into an internal tube chamber 405 that is configured to receive the sample. In some embodiments, the input end 402 may have a removable lid 403 that is adapted to cover the input opening 404 to seal the input end 402 of the sample tube 400.

In some embodiments, the sample tube 400 may include an output end 408 opposite of the input end 402. The output end 408 may include a port adapter 410. The output end 408 may be narrower than the input end 402. The port adapter 410 may adapted to release the sample received by the sample tube 400 through the port adapter 410 in response to being punctured. The sample tube 400 includes a tube body 401 extending between the input end 402 and the output end 408, the tube body 401 being narrower than the input end 402 and being wider than the output end 408.

In some embodiments, the sample tube 400 may be received by a microfluidic device. For instance, as illustrated in FIGS. 1A-1E, the sample tube 400 (e.g., the sample tube 102) may be received by the microfluidic device through a top cover of the microfluidic device to connect with a sample distribution member. In some embodiments, the sample tube 400 may be received by a sample tube adapter 406 which may be configured to receive and hold the sample tube 400 in place with respect to the microfluidic device. FIGS. 4G-4H illustrate the sample tube 400 received by the sample tube adapter 406 and closed by the removable lid 403. FIG. 4I illustrates an exploded view of the removable lid 403, the sample tube adapter 406, and the sample tube 400. In some embodiments, the lid 403 may be configured to seal and/or close the sample tube adapter 406. Additionally or alternatively, the lid 403 may seal and/or close the sample tube 400.

Also, FIG. 4B shows the sample tube 400 having a film 419 that covers the output end 408. The material of the film 419 can be punctured, by the sample distribution member. For instance, the film 419 may be configured to hold the samples received by the sample tube 400 within the sample tube 400 until the film 419 is punctured to let the samples flow out of the sample tube 400.

FIG. 4C shows up upper view of the sample tube 400. In some embodiments, the sample tube 400 may include one or more pointed wings 420. In these and other embodiments, the pointed wings may be configured to guide the sample provided to the input opening 404 into the internal tube chamber 405. For instance, the pointed wings may be placed at an angle to guide the sample down into to the internal tube chamber 405. In some embodiments, the pointed wings 420 may allow for a swab 450 to provide the sample by placing the swab 450 between the guides. The pointed wings 420 may be configured to squeegee, wring, and/or coax the sample from a swab head 452.

For example, the swab head 452 may be inserted between the one or more pointed wings 420 to allow the sample to drip or otherwise transfer into the internal tube chamber 405. Also, the swab head 452 may be pressed against one or both pointed wings 420 to coax the sample from the swab head 452. A narrow opening between the pointed wings 420 may allow the sample to be removed from the swab. In some instances, the swab may be easily used for mucosal, oral, buccal, vaginal, rectal, nasal, ear, skin, or other swabbing to obtain the sample. FIG. 4G shows such a swab 450 having the swab head 452 with the sample.

In some embodiments, an inert fluid can be used to push the biological sample through the microfluidic channels to the reaction chamber. That is, after the biological fluid is in the bottom of the sample tube, within the microfluidic pathway, or any place leading to the reaction chamber, an oil or silicone or other inert material can be pressed or pumped into the sample tube and then microfluidic channels in order to push the maximum amount of biological sample into the reaction chambers.

FIGS. 5A-5F illustrate different perspective of a sample distribution member 500 in accordance with one or more embodiments of the present disclosure. In some embodiments, the sample distribution member 500 may include a port member 502 having a conical body with a tapered input tip 504. The tapered input tip 504 may be configured to be coupled with the port adapter 410 of the output end 408 of the sample tube 400 of FIGS. 4A-4B. The port member 502 includes an output end 506 with a port conduit 510 extending between a tip opening 512 at the input tip 504 to an output opening 514 at the output end 506. The tapered input tip 504 is configured to puncture the film 419 of the sample tube 400 to obtain the sample from the port adapter 410 at the output end 408 of the sample tube 400.

The sample distribution member 500 may include a microfluidic network 522 coupled with the output end 506 of the port member 502. The microfluidic network 522 may include one or more microfluidic channels 524 having a microfluidic channel inlet 526 fluidly coupled with the output opening 514 at the output end 506 of the port member 502. Each microfluidic channel 524 includes a microfluidic channel outlet 528 to each reaction chamber 530 of each reaction vessel 532. Here, the reaction vessel 532 is the portion of the body that defines the reaction chamber 530.

The sample distribution member 500 may include one or more reaction vessels 532. The reaction vessels 532 may include corresponding reaction chambers 530. In these and other embodiments, the one or more reaction chambers 530 are fluidly coupled with the microfluidic channel outlet 528 of the one or more microfluidic channels 524. In these and other embodiments, the sample entered through the port member 502 may be distributed to the one or more reaction chambers 530 via the microfluidic channels 524. In some embodiments, the microfluidic channels 524 may be sealed by a microfluidic seal. For example, the microfluidic seal may be configured to enclose the microfluidic channels 524. In some embodiments, the sample distribution member 500 may include an even number of reaction chambers. For example, FIGS. 5A-5F illustrate the sample distribution member 500 including four reaction chambers 530. In some embodiments, the sample distribution member 500 may include any other suitable number of reaction chambers.

In some embodiments, the one or more reaction vessels 530 may further include corresponding vents 531. The vents 531 may be configured allow air to flow through the reaction chambers 530. In some embodiments, the air flow may improve process of the reactions between the reagents and the sample.

In some embodiments, the one or more reaction vessels 532 may be organized in a linear manner. For example, the one or more reaction vessels 532 may be positioned linearly with respect to each other. However, other arrangements, such as staggered, columns and rows, or other array formats can be used. In some embodiments, the sample distribution member 500 may be placed between the first circuit board 202 and the second circuit board 210 of the reactor member 200 of FIGS. 2A-2E.

In some embodiments, each of the reaction vessels 530 may include corresponding light pipes 534. In these and other embodiments, the light pipes 534 may be configured to direct lights from LEDs to the reaction chambers 530. For example, the light pipes 534 may guide lights from the LEDs 204 of FIGS. 2A-2E. For instance, the sample distribution member 500 may be placed between the first circuit board 202 and the second circuit board 210 such that the light pipes are removably coupled with the LEDs 204. The LEDs 204 may transmit light into the reaction chambers 530. The light may interact with reaction between the reagents and the samples in the reaction chambers 530 to generate light signals representing results of the reactions. In these and other embodiments, the light signals may go through top portions of the reaction vessels 530 to reach the receivers 206.

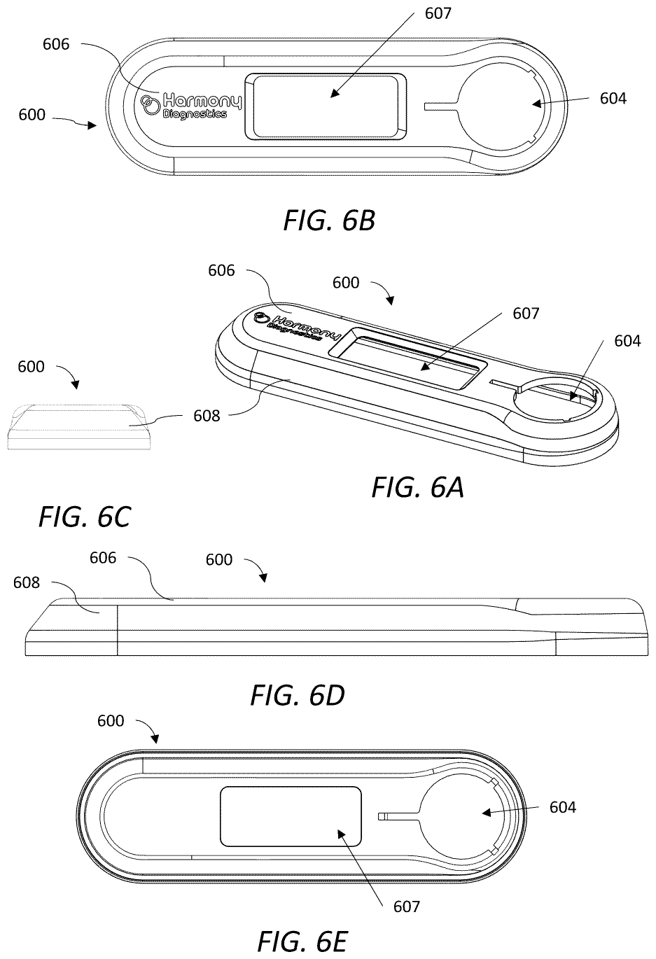

FIGS. 6A-6E illustrate a top cover 600 of a microfluidic device, in accordance with one or more embodiments of the present disclosure. In some embodiments, the top cover 600 may include a body 608 a first slot 604 and a second slot 607 in an upper portion 606. The first slot 604 may be configured to receive a sample tube (e.g., the sample tube 400 of FIGS. 4A-4I) therein. In some embodiments, the first slot 604 may be shaped and/or sized such that at least a part of the sample tube may sit above the first slot 604 when the sample tube is received to by the first slot 604. In other embodiments, the first slot 604 may be shaped and/or sized such that the sample tube may sit flush with the first slot 604. The second slot 607 may be configured to allow observation of a readout display, such as the display 214 of FIGS. 2A-2E. In some embodiments, the top cover 600 may be shaped as an oval. For example, the top cover 600 may include rounded edges. In other embodiments, the top cover 600 may include any other suitable shapes such as a rectangle, circle, square, among others. The slots may be considered to be apertures or holes in the body.

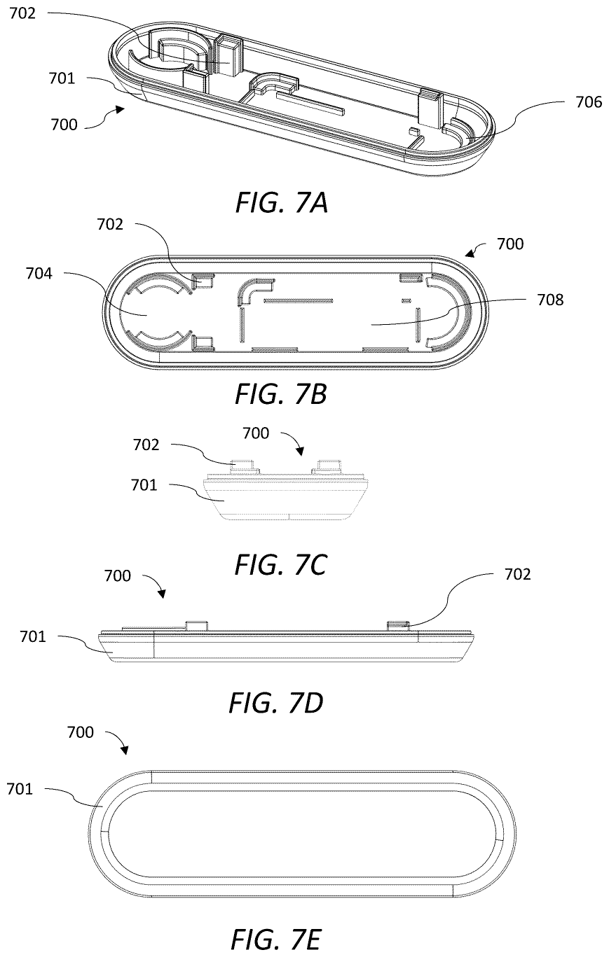

FIGS. 7A-7E illustrate a bottom member 700 in varying perspectives. The bottom member 700 may correspond to the bottom member 114 of FIGS. 1A-1E. The bottom member 700 may mate with the top cover 600 to enclose the reactor member 200, the sample distribution member 500, and the inner cover 300. In some embodiments, the bottom member 700 may include a bottom shell 701 defining a shape of the bottom member 700. Inner portion of the bottom member 700 may be shaped by sidewalls 706. In some embodiments, the bottom member 700 may include one or more supporting structures 702. The one or more supporting structures 702 may be configured to receive and hold different parts of a diagnostic system such as a reactor member, microfluidic device, and/or a battery.

In some embodiments, the battery may be configured to be received in a first bottom chamber 704 and the reactor member may be received in a second bottom chamber 708. In some embodiments, the bottom member 700 may be shaped corresponding to the top cover 600 to substantially seal components therein when mated with the top cover 600.

FIGS. 8A-8D illustrate a sample distribution member 805 placed within a reactor member 800, in accordance with one or more embodiments of the present disclosure. In some embodiments, the reactor member 800 may include a first circuit board 802 and a second circuit board 810. In these and other embodiments, the first circuit board 802 and the second circuit board 810 may be coupled using a connector 812. For instance, the first circuit board 802 and the second circuit board 810 may be spread out at a first distance. In some embodiments, the sample distribution member 805 may be placed between the first circuit board 802 and the second circuit board 810.

In some embodiments, the first circuit board 802 may include one or more LEDs 804. In these and other embodiments, the LEDs 804 may be aligned with one or more light pipes 834 of the sample distribution member 805. For instance, the sample distribution member 805 may be placed such that each of the light pipes 834 is placed on top of a LED 804. In some embodiments, the LEDs 804 may transmit light into one or more reaction chambers 830 through the light pipes 834. The reaction chambers 830 may receive a sample therein which may be reacted with one or more reagents in the reaction chambers 830. The lights transmitted by the LEDs 804 may be modified and/or transformed to generate light signals representing reaction results.

In some embodiments, the light signals may be received by one or more receivers 806 located on the second circuit board 810. The receivers 806 may determine the reaction results from the light signals. Additionally, the reaction results may be presented on a display 814 placed on the second circuit board 810.

In some embodiments, the reactor member 800 may include a battery 822 configured to provide power to the first circuit board 802, the LEDs 804, the second circuit board 810 and the display 814. In some embodiments, the battery 822 may be connected to the second circuit board 810 and power may be provided to the first circuit board through the connector 812. In other embodiments, the battery 822 may be connected to and/or placed on the first circuit board 802.

### EMBODIMENTS

In some embodiments, the system for analyzing a sample can include: a sample tube with an input end that is configured to receive the sample and having a lid removably coupled to the input end that is adapted to seal the input end of the sample tube, and having an output end opposite of the input end, the output end having a port adapter; a microfluidic device configured to be removably coupled with the sample tube.

In some embodiments, a system for analyzing a sample can include a sample tube with an input end having a removable lid and an output end, and a microfluidic device. The microfluidic device may include a port member configured to couple with the output end; a sample distribution member coupled with the port member and having a microfluidic network with microfluidic channels; reaction chambers fluidly coupled with the microfluidic channels; and a reactor member configured to generate and display light signals on a display, the light signals generated based on reactions in the reaction chambers and indicating results of the reactions.

In some embodiments, the input end includes an opening that is configured to receive the sample, in which the removable lid is adapted to cover the input opening to seal the input end of the sample tube. In some embodiments, the output end of the sample tube includes a port adapter configured to couple with the port member. In some embodiments, the port member has a tapered input tip configured to puncture the port adapter at the output end to obtain the sample from the port adapter. In some embodiments, the port adapter is configured to couple with a port in the microfluidic device.

In some embodiments, the one or more microfluidic channels include a microfluidic channel inlet fluidly coupled with the output end of the port member. In some embodiments, the microfluidic device further comprises one or more light pipes (e.g., waveguide, fiber optic, etc.) coupled with the one or more reaction chambers, the one or more light pipes configured to guide the light signals into the one or more reaction chambers.

In some embodiments, reactor member may include: a first circuit board configured to receive the microfluidic device covered with an inner cover. In some embodiments, the first circuit board may include: a set of LEDs corresponding to the one or more reaction chambers, the set of LEDs configured to transmit light into the one or more reaction chambers using the one or more light pipes; and a heating member configured to provide heat to the one or more reaction chambers. In some embodiments, the reactor member may include a second circuit board coupled to the first circuit board.

In some embodiments, the second circuit board may include: one or more receivers configured to receive the light signals from the one or more reaction chambers. In some embodiments, the reactor member may further include the display including a set of indicators corresponding to the one or more reaction chambers, the set of indicators configured to indicate results of the reaction between the sample and the reagents.

In some embodiments, the inner cover is configured to direct the light from the one or more reaction chambers to corresponding receivers without interacting among the light signals. In some embodiments, the system further comprises a connector coupled between the first circuit board and the second circuit board, in which the connector places the second circuit board above the first circuit board with a space therebetween. In some embodiments, the microfluidic device covered with the inner cover is placed between the first circuit and the second circuit. In some embodiments, the heating member is an electronic heater. In some embodiments, the output end of the sample tube includes a puncturable membrane material, such as an elastomer, rubber, or thermoplastic. In some embodiments, the one or more reaction chambers are aligned linearly with respect to each other.

In some embodiments, the system further includes one or more reagents placed in the one or more reaction chambers, the one or more reagents adapted to interact with a target analyte in the sample. In some embodiments, at least one of the one or more reagents is configured to test for a sexually transmitted disease. Additionally or alternatively, in some embodiments, at least one of the one or more reagents is configured to detect a virus.

In some embodiments, the sample tube is configured for receiving a swab, the reaction tube being configured for passing the content of the swab to the port member. In some embodiments, the sample tube includes a spout at in the input end, wherein the removable lid is configured to cover the spout. In some embodiments, the one or more reaction chambers include corresponding one or more vents configured to permit air flow through the reaction chambers. In some embodiments, the system further comprises a plunger adapted to fit into the sample tube and function as a syringe for delivering the sample into the microfluidic network to the reaction chambers. In some embodiments, the system further comprises a sample tube adapter coupled to the main slot of the top cover, the sample tube adapter configured to receive and secure the sample tube in place. In some embodiments, the one or more reaction chambers include a top portion that allows the light signals to transmit through.

In some embodiments, a method of analyzing a sample can include: providing the system for analyzing a sample as discussed above. The method may further include introducing a sample into the one or more reaction chambers and observing an indicator of the system of whether or not the sample includes a target analyte.

In some embodiments, the sample is obtained via a sample tube, the sample adapted to couple with a microfluidic device configured to distribute the sample into the one or more reaction chambers. In some embodiments, the one or more reaction chambers each include a reagent pre-deposited in the one or more chambers to interact with a target analyte in the sample. In some embodiments, the indicator is determined based on light signals corresponding to the one or more chambers, the light signals generated based on interaction between the reagent and the sample.

In some embodiments, the microfluidic device can include: a port member having an input tip adapted to couple with the port adapter of the output end of the sample tube, and having an output end with a port conduit extending between the input tip to the output end, wherein the input tip is configured to puncture the port adapter to obtain the sample from the port adapter at the output end of the sample tube; a sample distribution member coupled with the output end of the port member and having a microfluidic network with one or more microfluidic channels; one or more reaction chambers fluidly coupled with the one or more microfluidic channels; one or more light pipes coupled with the one or more reaction chambers, the one or more light pipes configured to sit on top of one or more LEDs of a reactor member, the reactor member including a first circuit board and a second circuit board, wherein the one or more LEDs are located on the first circuit board; the one or more LEDs configured to transmit light into the one or more reaction chambers to generate light signals representing results of reaction between reagents and the sample within the one or more reaction chambers; the second circuit board including one or more receivers configured to receive the light signals and transmit the reaction results to a display; an inner cover coupled between the second circuit board and the one or more reaction chambers, wherein the inner cover is configured to separate the one or more reaction chambers from each other to prevent the light signals from interfering with each other; a battery configured to provide power to the reactor member; a top cover with first portion and a second portion, wherein the first portion includes a first slot configured to receive the sample tube therein, and the second portion includes a second slot corresponding to the display; and a bottom member mating with the top cover to enclose the port member, sample distribution member, the reactor member, and the inner cover. A reagent can be located in at least one of the reaction chambers that is adapted to provide a colorimetric reading upon interaction with a target analyte in the sample. The plurality of reaction chambers allows for a plurality of different reactions. Also, each diagnostic reaction may include a positive and a control reading, which uses two reaction chambers for the diagnostic.

In some embodiments, a method of manufacturing a sample analyzing system is provided. A bottom member can be obtained. The bottom member can include one or more support members configured to receive and support a reactor member. The reactor member can include a first circuit board and a second circuit board, wherein the first circuit board and the second circuit board are connected by connectors, the second circuit board being at a distance above the first circuit board. The reactor member can receive a sample distribution member between the first circuit board and the second circuit board. The sample distribution member can have one or more microfluidic channels of a microfluidic network. The sample distribution member also has a port member fluidly coupled with the one or more microfluidic channels. The port member can have a conical body with a tapered input tip.

One or more reaction chambers can be affixed to the sample distribution member, such as by being integrated therewith (e.g., molded, 3D printed, etc.) or as separate chambers coupled to the distribution member. The one or more reaction chambers are fluidly coupled with the one or more microfluidic channels. Each reaction chamber contains a reagent that is adapted to provide a colorimetric reading upon interaction with a target analyte. The one or more reaction chambers can have one or more light pipes coupled to the one or more reaction chambers. The one or more light pipes can be coupled between the one or more reaction chambers and one or more LEDs coupled to the first circuit board such that light from the LEDs are transmitted into the one or more reaction chambers through the light pipes. The reactions between the reagent and the sample may interact with the light from the LEDs to transmit the reaction results, via light signals, to one or more receivers coupled to the second circuit board. The reactor member may be powered by a battery coupled to the second circuit board.

The one or more reaction chambers can be covered by an inner cover, wherein the inner cover is configured to prevent the light signals from individual reaction chambers from mixing and/or interfering with each other while being transmitted to the one or more receivers. A colorimetric analysis can be performed on the light signals received by the receivers and results can be provided on a display coupled to the second circuit board.

In some embodiments, the sample analyzing system can have a top cover. The top cover is configured to mate with the bottom member to enclose the reactor member, the sample distribution member, the inner cover, and the battery and form a housing. The top cover has a first slot and a second slot, wherein the first slot is configured to receive a sample tube therein, and the second slot is configured to allow viewing of the display.

In some embodiments, the sample analyzing system may further include heating mechanisms coupled to the first circuit board, wherein the one or more reaction chambers may be placed on top of the heating mechanisms. The heating mechanisms may provide heat to the reaction chambers that may require heat to initiate and/or speed up reaction between the reagents and the sample.

The reaction chambers of the microfluidic device can include reagents to react with a target analyte when present. This allows for colorimetric assays, which provide a defined color when the target analyte is present.

The biological sample can be any type from a swab in the nose, mouth, penis tip, vagina, anus, or other location. The swab can be placed into the sample tube, and a sample buffer can be introduced therewith. The sample buffer can transport the target analytes from the swab to the reaction chambers for the diagnostics.

In some examples, the biological sample can be a fluid such as blood, plasma, or extract therefrom. The blood can be processed to obtain fractions thereof or components thereof. The plasma may also be separated from the blood and used in the sample tube.

In some examples, the biological sample can be urine.

In some examples, the biological sample can be hair, where a solvent is added as a sample solvent to carry the target analyte.

In some examples, the biological sample can be feces, where the sample buffer can be used to obtain target analyte therefrom. The sample may be filtered before being introduced into the sample tube.

The sample tube and cartridge can be provided together as a kit. The cartridge can be the microfluidic reaction device descried herein that includes reaction reagents in the reaction chambers thereof. The microfluidics move the sample from the tube to the reaction chambers for diagnostic reactions.

In some embodiments, the sample is from a swab.

In some embodiments, a method of analyzing a sample, such as from a swab, is provided. The method can include obtaining a sample in a sample tube. The sample is put into the tube at an input end with an input opening. The sample tube also has an output end having a port adapter. The port adapter configured to release the sample in response to being punctured or otherwise coupling with the assay cartridge. The port adapter of the sample tube can be connected to a port member of a microfluidic device of the cartridge. The port member can have a conical body with a tapered input tip adapted to couple with the port adapter and having an output end with a port conduit extending between a tip opening at the input tip to an output opening at the output end. The tapered input tip can be configured to puncture the port adapter to obtain the sample from the sample tube. Alternatively, the tapered input tip can be configured to fluidly couple with the port adapter to receive the contents of the sample tube therefrom. The sample can be distributed to one or more reaction chambers via the microfluidic network of the cartridge. The sample may use wicking to draw from the reaction tube to the reaction chambers. Also, a sample buffer can be introduced into the sample tube to carry the sample and target analyte therein through the port into the microfluidic network and to the reaction chambers. The sample distribution member can have a microfluidic network with one or more microfluidic channels. The one or more microfluidic channels can have a microfluidic channel inlet fluidly coupled with the output opening at the output end of the port member. In some embodiments, the one or more microfluidic channels may stem from a main microfluidic channel. For example, the main microfluidic channel may be fluidly coupled to the port member and the main microfluidic channel may divide into the one or more microfluidic channels connected to the reaction chambers. Also, the channels can each include a microfluidic channel outlet fluidly coupled with the one or more reaction chambers.

Heat can be provided to the one or more reaction chambers by an electric heater. The electric heater can be placed on a first circuit board configured to receive the one or more reaction chambers. The one or more reaction chambers may be placed on top of the electric heater which can provide heat to the one or more reaction chambers.

The distributed sample then interacts with a reagent pre-deposited in each reaction chamber under heat from the electric heater. The reagent can be adapted to provide a colorimetric reading upon interaction with a target analyte in the sample. The one or more reaction chambers may be coupled with one or more light pipes. The light pipes may connect and/or sit on top of one or more LEDs of the first circuit board. For instance, when the one or more reaction chambers are placed on top of the electric heater, the light pipes may be placed on top of the LEDs. The LEDs may transmit light into the one or more reaction chambers to generate light signals indicative of the colorimetric reading. The light signals may be received by one or more receivers coupled to a second circuit board which may perform a colorimetric analysis on the light signals.

Results of the colorimetric analysis may be provided on a display. The display may include a description of different tests, such as the target analyte being tested for, and one or more indicators corresponding to the different tests. The one or more indicators may provide the results through different colors.

The reagent can be in a lyophilized powder with the carrier, and configured to be retained in the reaction chamber without passing through the pin hole. A pressure sensitive adhesive can be used for a backing to cover the channels and thereby provide a cover for the reaction chambers. This can keep the reagent in the reaction chamber without falling out.

In some embodiments, an example of reactions between the reagents and the sample can be for detection of sexually transmitted diseases (STD). For example, the reaction chambers can include reagents that react with gonorrhea, Chlamydia, trichomonas, human papilloma virus (HPV) to provide for the diagnostics.

In another example, CRISPR reagents can be included within the reaction chambers to perform CRISPR analysis.

Another example includes assay reagents for hypophosphatasia (HPP).

Another example includes assay reagents to detect a virus, such as flu, covid, or others.

The reaction chambers of the microfluidic device can include reagents to react with a target analyte when present. This allows for colorimetric assays, which provide a defined color when the target analyte is present.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety. Particularly, U.S. application Ser. No. 18/659,540 filed May 9, 2024 and U.S. Provisional Application No. 63/501,322 filed May 10, 2023 are incorporated herein by specific reference.

1. A system for analyzing a sample comprising:
a sample tube with an input end having a removable lid and an output end;
a microfluidic device comprising:
a port member configured to couple with the output end of the sample tube;
a sample distribution member coupled with the port member and having a microfluidic network with one or more microfluidic channels;
one or more reaction chambers fluidly coupled with the one or more microfluidic channels; and
a reactor member configured to generate and display light signals on a display, the light signals generated based at least on reactions in the one or more reaction chambers and indicating results of the reactions.

2. The system of claim 1, wherein the input end includes an input opening that is configured to receive the sample, wherein the removable lid is adapted to cover the input opening to seal the input end of the sample tube.

3. The system of claim 1, wherein the output end of the sample tube includes a port adapter configured to couple with the port member.

4. The system of claim 3, wherein the port member has a tapered input tip configured to puncture the port adapter at the output end to obtain the sample from the port adapter.

5. The system of claim 3, wherein a port adapter is configured to couple with a port in the microfluidic device.

6. The system of claim 1, wherein the one or more microfluidic channels include a microfluidic channel inlet fluidly coupled with the output end of the port member.

7. The system of claim 1, wherein the microfluidic device further comprises one or more light pipes coupled with the one or more reaction chambers, the one or more light pipes configured to guide the light signals into the one or more reaction chambers.

8. The system of claim 7, wherein the reactor member comprises:
a first circuit board configured to receive the microfluidic device covered with an inner cover, comprising:
a plurality of LEDs corresponding to the one or more reaction chambers, the plurality of LEDs configured to transmit light into the one or more reaction chambers using the one or more light pipes; and
a heating member configured to provide heat to the one or more reaction chambers; and
a second circuit board coupled to the first circuit board, comprising:
one or more receivers configured to receive the light signals from the one or more reaction chambers; and
the display including a plurality of indicators corresponding to the one or more reaction chambers, the plurality of indicators configured to indicate results of the reaction between the sample and one or more reagents.

9. The system of claim 8, wherein the inner cover is configured to direct the light signals from the one or more reaction chambers to corresponding receivers without interacting among the light signals.

10. The system of claim 8, further comprising a connector coupled between the first circuit board and the second circuit board, wherein the connector places the second circuit board above the first circuit board with a space therebetween.

11. The system of claim 8, wherein the microfluidic device covered with the inner cover is placed between the first circuit board and the second circuit board.

12. The system of claim 8, wherein the heating member is an electronic heater.

13. The system of claim 1, wherein the output end of the sample tube includes a puncturable membrane material, such as an elastomer, rubber, or thermoplastic.

14. The system of claim 1, further comprising one or more reagents placed in the one or more reaction chambers, the one or more reagents adapted to interact with a target analyte in the sample.

15. The system of claim 14, wherein at least one of the one or more reagents is configured to test for a sexually transmitted disease.

16. The system of claim 14, wherein at least one of the one or more reagents is configured to detect a virus.

17. The system of claim 1, wherein the sample tube is configured for receiving a swab, the sample tube being configured for passing content of the swab to the port member.

18. The system of claim 1, wherein the one or more reaction chambers include corresponding one or more vents configured to permit air flow through the reaction chambers.

19. The system of claim 1, further comprising a plunger adapted to fit into the sample tube and function as a syringe for delivering the sample into the microfluidic network to the reaction chambers.

20. The system of claim 1, further comprising a sample tube adapter configured to receive and secure the sample tube in place.

21. The system of claim 1, wherein the one or more reaction chambers include a top portion that allows the light signals to transmit through.

22. A method of analyzing a sample comprising:
providing the system of claim 1;
introducing a sample into the one or more reaction chambers;
observing an indicator of the system of whether or not the sample includes a target analyte.

23. The method of claim 22, wherein the sample is obtained via a sample tube, the sample adapted to couple with a microfluidic device configured to distribute the sample into the one or more reaction chambers.

24. The method of claim 22, wherein the one or more reaction chambers each include a reagent pre-deposited in the one or more chambers to interact with the target analyte in the sample.

25. The method of claim 24, wherein the indicator is determined based on light signals corresponding to the one or more chambers, the light signals generated based on interaction between the reagent and the sample.
